(19) United States
(12) Patent Application Publication
(10) Pub. No.: US 2017/0140145 A1
(43) Pub. Date: May 18, 2017

(54) COMPUTER-CONTROLLED PHYSICALLY DISTRIBUTED COLLABORATIVE ASYNCHRONOUS DIGITAL TRANSACTIONS

(71) Applicant: Netspective Communications LLC, Silver Spring, MD (US)

(72) Inventor: Shahid N. Shah, Silver Spring, MD (US)

(21) Appl. No.: 15/418,765

(22) Filed: Jan. 29, 2017

Related U.S. Application Data
(63) Continuation-in-part of application No. 13/871,107, filed on Apr. 26, 2013.
(60) Provisional application No. 61/646,744, filed on May 14, 2012.

(51) Int. Cl. G06F 21/44

(52) U.S. Cl. CPC G06F 21/44

(57) ABSTRACT

A system for facilitating asynchronous digital transactions among a plurality of computer-controlled devices associated with a plurality of respective nodes. The system includes a first digital information database to store computerized identity information pertaining to the plurality of respective nodes and the associated plurality of computer-controlled devices. The system further includes a cognitive interactive human-machine interface configured to allow the plurality of computer-controlled devices and the associated nodes to interact digitally among them and with the system and with an external authorized node. The cognitive interactive human-machine interface is configured to receive at least one sensed stimulus from at least one of the computer-controlled devices and transmit digital information contained in the at least one sensed stimulus at least in part to the external authorized node to annotate the digital information by generating a digital input.

### CROSS-REFERENCE TO RELATED APPLICATIONS

The application is a continuation-in-part of U.S. patent application Ser. No. 13/871,107 filed on Apr. 26, 2013, which claims priority to U.S. provisional application No. 61/646,744 filed on May 14, 2012, the complete disclosures of which, in their entireties, are herein incorporated by reference.

### BACKGROUND

Technical Field

The embodiments herein generally relate to digital communication, and more particularly to collaborative asynchronous digital transactions among a plurality of computer-connected systems and devices and associated nodes.

Description of the Related Art

Computer networks include a variety of nodes connected over a network. These nodes rely on one another for the information necessary to perform their respective roles because the communication packets are delivered asynchronously through numerous locations and numerous persons and organizations that may be related or unrelated. As a result, a plethora of storage, retrieval, and collaboration systems are required to support the flow of communication packets among the various nodes and devices thereof. There is a need for an improved distributed and trusted system for collaborative digital engagement among a set of connected computer-controlled devices over communication networks associated with various nodes.

### SUMMARY

An embodiment herein provides a system for facilitating collaborative asynchronous digital transactions enabled through a blockchain configured digital integrity network among a plurality of computer-controlled devices associated with a plurality of respective nodes. The system includes a first digital information database to store computerized identity information pertaining to the plurality of respective nodes and the associated plurality of computer-controlled devices. The system further includes a cognitive interactive human-machine interface configured to allow the plurality of computer-controlled devices and the associated nodes to interact digitally among them and with the system and with an external authorized node. The cognitive interactive human-machine interface is configured to receive at least one sensed stimulus from at least one of the computer-controlled devices and transmit digital information contained in the at least one sensed stimulus at least in part to the external authorized node to annotate the digital information by generating a digital input. The digital input is indicative of a change or no change in a digital planned scheme of delivery for a node associated with the at least one of the computer-controlled devices that generates the at least one sensed stimulus. The system includes a controller communicatively connected with the authorized external node and with the cognitive interactive human-machine interface to process the at least one sensed stimulus for comprehension and conversion into the digital information for transmission to the external authorized node and to process the digital input received from the external authorized node. The controller includes a blockchain configured identity validation device to verify identity of the at least one of the plurality of computer-controlled devices generating the sensed stimulus based on the pre-stored identity information in the first digital information database and an electronic signature received from the at least one of the computer-controlled devices along with the at least one sensed stimulus. The controller further includes a computerized trust system that evaluates trustworthiness and ‘device integrity’ of the at least one of the computer-controlled devices that generates the at least one sensed stimulus associated with the respective node participating in the asynchronous digital transactions and generate a digital signal indicative of a trust score associated with the at least one of the computer-controlled devices and the associated node. The controller is configured to attest veracity and trustworthiness of the at least one sensed stimulus based on inputs received from the blockchain configured identity validation device and the computerized trust system such that an attestation is indicative of a change in the digital planned scheme of delivery based on the sensed stimulus. The controller is configured to attest identity of the external authorized node based on a node token received by the controller from the external authorized node, wherein the node token represents a unique digital identity of the authorized external node. The controller is configured to cause the blockchain configured network to update the digital planned scheme of delivery in view of the determined change in the digital planned scheme of delivery as identified from the digital input received from the external authorized node. The controller is configured to notify the at least one of the computer-controlled devices of the determined change. The step of notifying includes generating an electric signal comprising data signifying the determined change and instructions for compliance toward an updated digital planned scheme of delivery, transmitting the electric signal in the network comprising the plurality of communicatively linked computer-controlled devices, converting the electric signal into a plurality of pixels, and displaying the plurality of pixels on a display unit of the at least one of the computer-controlled devices to launch an activation message that includes an instruction in accordance with the determined change and the updated planned scheme of delivery.

### BRIEF DESCRIPTION OF THE DRAWINGS

The embodiments herein will be better understood from the following detailed description with reference to the drawings, in which:

FIG. 1 is a block diagram illustrating an exemplary system in which various embodiments herein may operate;

FIG. 2 is a block diagram illustrating an example of a configured to facilitate collaborative digital interactions according to an embodiment herein;

FIG. 3 illustrates a computer-controlled device communicatively connected with associated devices that generate a sensed stimulus according to an embodiment herein;

FIG. 4 illustrates an exemplary chart to indicate monitoring of compliance by a tracking device using an electric compliance component of the sensed stimulus according to an embodiment herein;

FIG. 5 illustrates an exemplary blockchain configured ecosystem for facilitating digital transactions among various devices according to an embodiment herein;

FIG. 6 is a block diagram illustrating an example of a hardware environment for practicing the embodiments depicted in FIGS. 1 through 5.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings that form a part hereof, and these are shown by way of illustrating specific embodiments herein that may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

In this document, the terms “a” or “an” are used, as is common in patent documents, to include one or more than one. In this document, the term “or” is used to refer to a “nonexclusive or” unless otherwise indicated.

In an exemplary embodiment, the various modules described herein and illustrated in the figures are embodied as hardware-enabled modules and may be configured as a plurality of overlapping or independent electronic circuits, devices, and discrete elements packaged onto a circuit board to provide data and signal processing functionality within a computer. An example might be a comparator, inverter, or flip-flop, which could include a plurality of transistors and other supporting devices and circuit elements. The modules that are configured with electronic circuits process computer logic instructions capable of providing digital and/or analog signals for performing various functions as described herein. The various functions can further be embodied and physically saved as any of data structures, data paths, data objects, data object models, object files, database components. For example, the data objects could be configured as a digital packet of structured data. The data structures could be configured as any of an array, tuple, map, union, variant, set, graph, tree, node, and an object, which may be stored and retrieved by computer memory and may be managed by processors, compilers, and other computer hardware components. The data paths can be configured as part of a computer CPU that performs operations and calculations as instructed by the computer logic instructions. The data paths could include digital electronic circuits, multipliers, registers, and buses capable of performing data processing operations and arithmetic operations (e.g., Add, Subtract, etc.), bitwise logical operations (AND, OR, XOR, etc.), bit shift operations (e.g., arithmetic, logical, rotate, etc.), complex operations (e.g., using single clock calculations, sequential calculations, iterative calculations, etc.). The data objects may be configured as physical locations in computer memory and car be a variable, a data, structure, or a function. In the embodiments configured as relational databases (e.g., such Oracle® relational databases), the data objects can be configured as a table or column. Other configurations include specialized objects, distributed objects, object oriented programming objects, and semantic web objects, for example. The data object models can be configured as an application programming interface for creating HyperText Markup Language (HTML) and Extensible Markup Language (XML) electronic documents. The models can be further configured as any of a tree, graph, container, list, map, queue, set stack and variations thereof. The data object files are created by compilers and assemblers and contain generated binary code and data for a source file. The database components can include any of tables, indexes, views, stored procedures, and triggers.

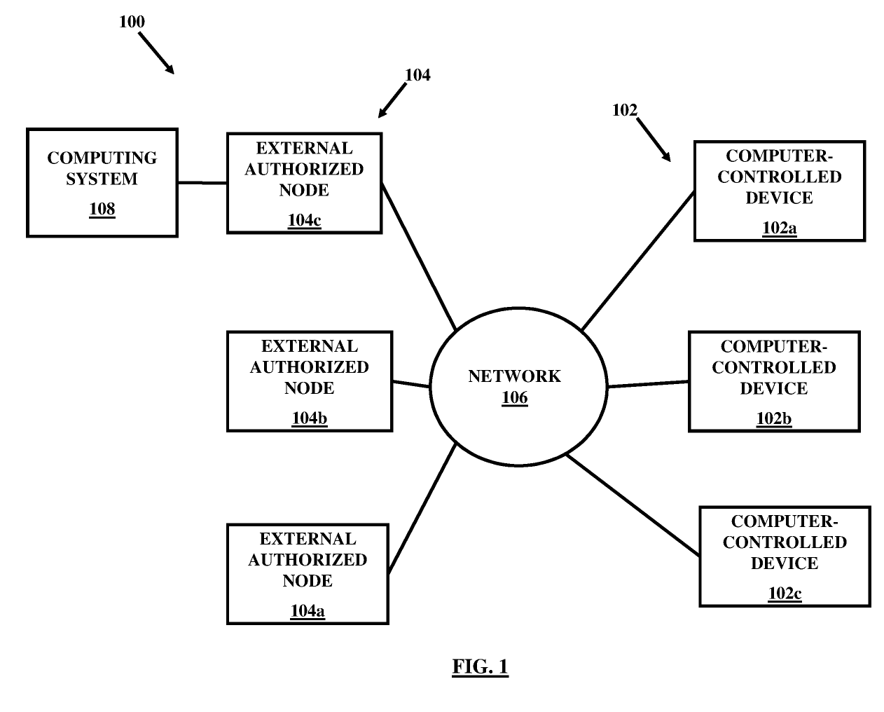

FIG. 1 illustrates generally, but not by way of limitation, among other things, an example of an environment or architecture or an ecosystem 100 in which various embodiments herein may operate. As illustrated in FIG. 1, the environment 100 constitutes a plurality of computer-controlled devices 102a, 102b, and 102c and external authorized nodes 104a, 104b, and 104c. The computer-controlled devices 102a, 102b, and 102c are together referred to as 102 and may be associated with respective nodes or entities who may be patients or subjects or their care takers etc. The computer-controlled devices 102 may be associated with a recipient of care such as a patient. The computer-controlled devices 102 may be associated with a patient-related entity such as family member of the patient. The external authorized nodes together referred to as 104 may be identified as care provider-related entity or associated computing systems who may be authorized to view and modify transaction information associated with various nodes in the form of digitally stored computer-executable files. The computer-controlled devices 102 and the external authorized nodes 104 may be communicatively in connection with each other over a network 106. In an embodiment, the interconnected network 106 of the various computer-controlled devices 102 and the external authorized nodes 104 together provide a system or architecture with a facility for collaborative digital engagement and computer-executable tasks enabling a shared collaborative trusted functioning of the various distributed computer-controlled devices 102 in the network 106. In an embodiment, the shared collaborative digital engagement within the network 106 can be facilitated through a blockchain configured ecosystem such that the network 106 can facilitate blockchain configured networking, communication, digital content storage, retrieval, sharing, attestations, and presentation. This can be achieved using a collaborative engagement model as shown in FIG. 1 among the various computer-controlled devices 102, associated nodes, and the external authorized nodes. In an example, each of the external authorized nodes may be associated with an associated computing system similar to computing system 108 shown in FIG. 1 as an example for participating in the digital transactions.

The external authorized nodes 104 may, for example, include entities and associated computing systems such as associated with nutritionists, exercise coaches, pharmacists, drug companies, insurance payers, doctors, physicians, care providers, and the like.

In an embodiment, the nodes associated with the computer-controlled devices 102 may represent a relative of a patient, a friend of a patient, or a neighbor of a patient, or any other person, individual, or association or group having some interests in the digital health planning of the patient. In an embodiment, the nodes associated with the computer-controlled devices 102 may represent a financial institution or a bank or an insurance company interested in understanding or knowing the health status and planning of the patient. In either of the cases, the computer-controlled devices 102 and other associated sensors and circuits as discussed later may be located in close proximity of a patient so that health parameters or digital parameters or a planned scheme of delivery may be monitored in association with a patient context. The planned scheme of delivery herein may represent a workflow of recommended guidelines and instructions for compliance by a patient (also referred to as a “subject” interchangeably without limitations) as part of an overall recommended treatment or routine. The planned scheme of delivery may be defined in terms of digital instructions stored in the form of computer-executable files for transmitting to the computer-controlled devices 102 by the external authorized nodes 104 after processing through controlling devices as discussed below.

In an embodiment, the external authorized nodes 104 may represent an authorized care provider who may be a doctor, physician, surgeon, health planning agency, health care unit, or any other similar individual or firm, center, or association capable or authorized to create or modify the digital instructions contained in the planned scheme of delivery.

In an embodiment, the external authorized nodes 104 are capable of issuing or modifying digital instructions contained in the planned scheme of delivery that can be in the form of digital prescriptions, computerized health tips, computerized diagnostic guidelines, computerized dietary control habit information, computerized food and nutritional guidelines, computerized disease prevention and control guidelines, and the like, and stored in the form of computer-executable files. These computer-executable files indicative of health matters and health planning practices can be aimed to be communicated to the computer-controlled devices 102 to educate the nodes associated with the computer-controlled devices 102. The digital instructions contained in the planned scheme of delivery can be aimed at identifying causes of the health issues associated with the patient and providing guidelines and recommendations for their cure through the computer-executable files.

In accordance with various embodiments, the computer-executable files generated by the external authorized nodes 104 or associated computing systems 108 can be accessed by the computer-controlled devices 102 so that the associated entities or nodes can track compliance or performance. Also, the computer-controlled devices 102 can access and/or receive feedback from the external authorized nodes 104 to understand compliance toward the digital instructions issued in the form of the computer-executable files. Thus, the entire networked architecture 100, as shown in FIG. 1, facilitates a collaborative distributed, inter-connected, digital engagement platform through asynchronous distributed digital transactions.

The network 106 can be a wireless or a wired network and/or a distributed blockchain configured network. The network 106 can operate as a communications network configuring communication among the computer-controlled devices 102, external authorized nodes 104 and associated devices, and the like. In an embodiment, the network 106 can be the Internet. The computer-controlled devices 102 can be distributed over a wide area and can connect remotely among themselves over the network 106.

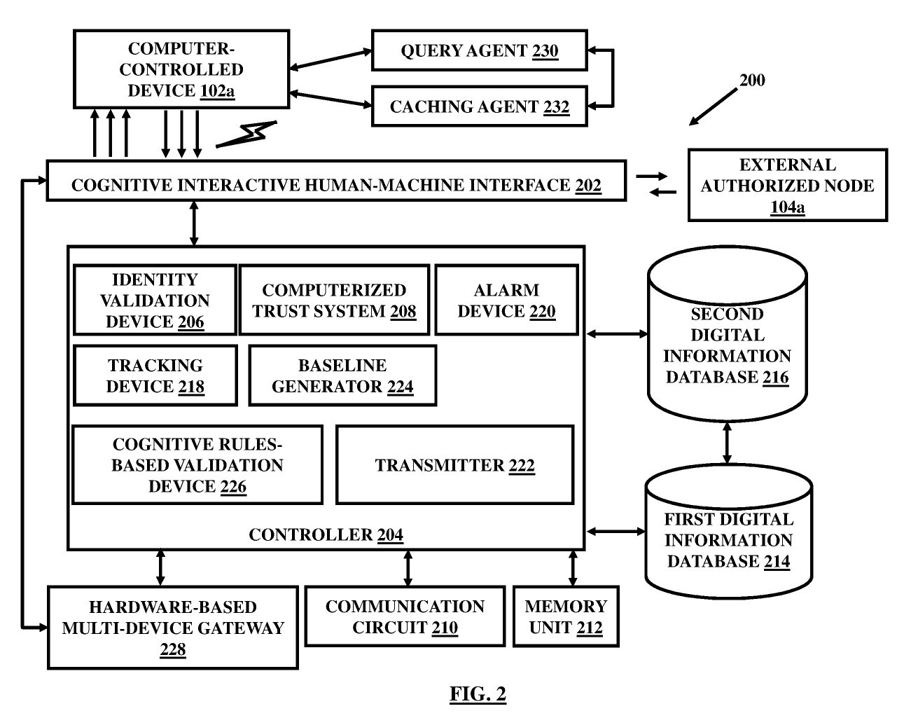

FIG. 2, with reference to FIG. 1, illustrates generally, but not by way of limitation, among other things, an example of a computer implemented system 200 configured to facilitate collaborative digital engagement and transactions among various devices and nodes as shown in FIG. 1 for tracking, and monitoring performance or compliance in view of the transmitted instructions digitally to the computer-controlled devices 102 with the use of the computer-executable files.

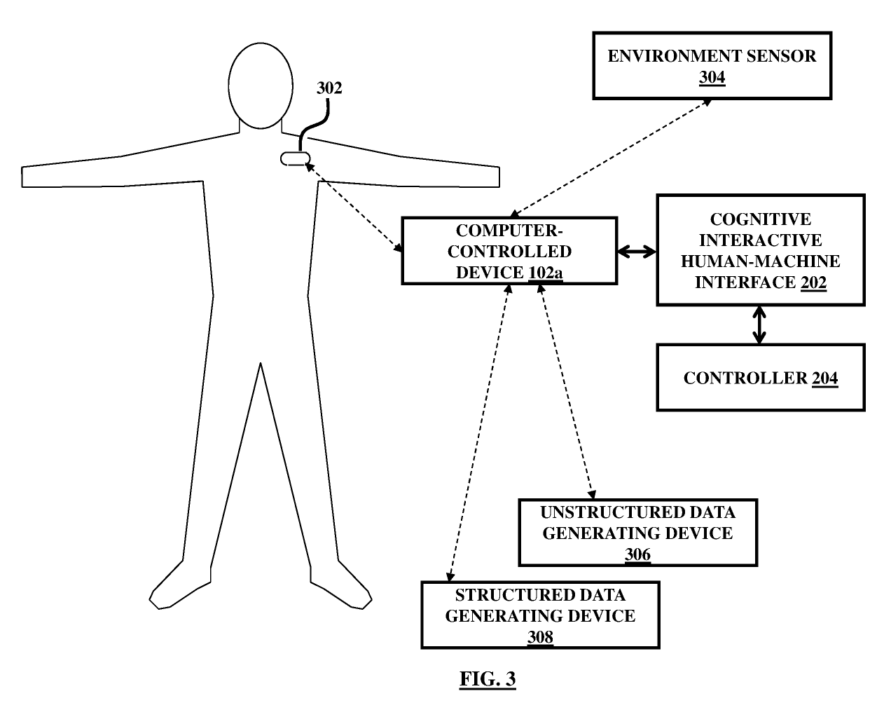

Each of the computer-controlled devices 102 may be capable of performing digital transactions over the network 106 and facilitate communication exchange with the system 200 and various components thereof as per requirements of the ecosystem 100. In an example, the computer-controlled devices 102 (and/or connected sensors as discussed later) may be configured to sense contextual changes and accordingly generate sensed stimuli. For example, the computer-controlled device 102a may sense a contextual change to generate at least one sensed stimulus and transmit the sensed stimulus to the system 200 over the network 106 as a computer-executable digital signal. The contextual change may represent an instantaneous real-time changed value. In an example, the sensed stimulus may represent an instantaneous and real-time contextual absolute value instead of a change in the context. The computer-controlled devices 102 may be associated with a variety of sensors and automation devices to allow sensing of the contextual changes or absolute context values or determinants of contexts. The computer-controlled device 102a, for example, may be associated with a physiological sensor and/or an environment sensor, and/or data generating sources as discussed later in conjunction with FIG. 3.

In an embodiment, the system 200 operates as a server-based system with a centralized storage and remote access to the computer-controlled devices 102, external authorized nodes 104, and associated computing systems such as 108. In an embodiment, the system 200 operates as a blockchain configured distributed access-based system. The system 200 includes a cognitive interactive human-machine interface 202 for facilitating the digital transactions among the computer-controlled devices 102, and the external authorized nodes 104 and their associated computing systems similar to 108. The cognitive interactive human-machine interface 202 also referred to as digital platform 202 or digital interface 202 for simplicity of description serves as an access point for the various nodes and the computer-controlled devices 102. In an embodiment, the system 200 operates as a multi-server or a single-server-based system with distributed storage and remote distributed access facility for the computer-controlled devices 102, external authorized nodes 104 and their associated systems such as 108 through a blockchain configured cognitive interactive human-machine interface 202 with several blockchain configured distributed multiple access points configured within the network 106.

The cognitive interactive human-machine interface 202 may be configured to facilitate the plurality of computer-controlled devices 102 and the associated nodes to interact digitally and collaboratively among them and with the system 200 and with the external authorized nodes 104. The cognitive interactive human-machine 202 interface may, for example, be configured to receive the sensed stimulus from the computer-controlled device 102a and transmit the sensed stimulus to one or more of the external authorized nodes 104 to comprehend the sensed stimulus and add annotations thereof asynchronously to create and/or update the digital instructions as part of the planned scheme of delivery. These annotations may be captured as digital inputs by the cognitive interactive human-machine interface 202. The digital inputs are indicative of whether a change is needed or suggested or no change is needed or suggested in the planned scheme of delivery for a node such as a patient associated with the computer-controlled device 102a that generates and/or transmits the sensed stimulus. In an embodiment, the digital inputs may be indicative of changing existing instructions. In an embodiment, the digital inputs may be indicative of creating new instructions altogether. In an embodiment, the digital inputs may be indicative of creating a new planned scheme of delivery. In an embodiment, the digital inputs may be indicative of updating an existing planned scheme of delivery. The decision as to whether the change is needed or not may be determined by a controller 204 based on the digital inputs received from the one or more of the external authorized nodes 104 such as from the node 104a and based on inputs generated by an identity validation device 206 and a trust system 208. The controller 204 and various components thereof are discussed hereafter.

The system 200 includes a communication circuit 210. The communication circuit 204 can be operatively coupled to the cognitive interactive human-machine interface 202 and can be configured to communicatively couple the various nodes and the computer-controlled devices 102, and the external authorized nodes 104 together and with the system 200 through the cognitive interactive human-machine interface 202 for transmission and receipt of digital communication. The communication circuit 210 may be configured to receive an input external from the system 200 such as from the computer-controlled devices 102, external authorized nodes 104, and the associated devices or generate an output or communicate an output generated within the system 200. The output can be configured to be received by the computer-controlled devices 102, the external authorized nodes 104, and various associated devices. The communication circuit 210 may be configured to receive the sensed stimulus from the computer-controlled devices 102. The system 200 further includes a memory unit 212 for storing programmed instructions within the system 200 for execution by the controller 204 and components thereof.

In an embodiment, the system 200 can include or be coupled to a first digital information database 214 to store computerized identity information pertaining to the plurality of respective nodes and associated respective plurality of computer-controlled devices 102. The identity information may include unique identifiers associated with the computer-controlled devices 102 and the associated nodes, and the external authorized nodes 104 which may be used to verify their identity during a digital transaction and/or during an access of the cognitive interactive human machine interface 202 by them. In an embodiment, the identity information may also include image patterns, voice patterns so as to perform image recognition and voice recognition for identity purposes by image recognition and voice recognition devices.

The system 200 can include or be coupled to a second digital information database 216 to store the computer-executable files indicative of digital parameters (or medical parameters) for use in creating and or updating the digital planned scheme of delivery for the nodes associated with the computer-controlled devices 102. The digital parameters may, for example, include various physiological and environmental determinants such that the planned scheme of delivery may be dependent on a combination of the digital parameters. The second digital information database 216 may also store a set of pre-determined reference values against each of the digital parameters so as to determine a fitting planned scheme of delivery for a particular node based on respective contextual values as obtained from the sensed stimulus and based on a combination of the digital parameters and associated reference values. The planned scheme of delivery may be generated automatically by the controller 204, in an embodiment. In an embodiment, the controller 204 may use the digital input from the external authorized node 104a in view of the information contained in the second digital information database 216 for generating and/or updating the planned scheme of delivery.

The controller 204 may be communicatively associated with the external authorized node 104a and operatively connected with the cognitive interactive human-machine interface 202 to process the at least one sensed stimulus for comprehension and process the digital input indicative of the annotations received from the external authorized node 104a. The controller 204 can be configured to process the programmed instructions as stored in the memory unit 208 for enabling a collaborative digital engagement or interaction through the system 200.

The controller 204 may include the blockchain configured identity validation device 206. The identity validation device 206 may verify identity of the computer-controlled device 102a generating the sensed stimulus based on the pre-stored identity information in the first digital information database 214 and based on an electronic signature received from the computer-controlled device 102a along with the at least one sensed stimulus. The electronic signature may be indicative of a blockchain token to uniquely represent a computer controlled device 102a of the plurality of computer-controlled devices 102 and associated nodes which may be matched for verification with the information stored in the first digital information database 214.

The controller 204 may include the computerized trust system 208. The computerized trust system 208 may be configured to evaluate the trustworthiness and ‘device integrity’ of the computer-controlled device 102a that generates the sensed stimulus associated with the respective node participating in the asynchronous digital transaction. The computerized trust system may process the sensed stimulus to generate a digital signal indicative of a trust score associated with the computer-controlled device 102a.

The trust system 208 may operate a mechanism that may allow each relying device that relies on other devices, to ascertain their trustworthiness state when needed, and thus augment or update its risk management process with relevant trustworthiness digital files. Accordingly, the trust system 208 may be provided and enabled with regard to the computer-controlled devices 102 and associated sensors and Internet-of-Things (IoT) devices. A target computer-controlled device such as 102a may need to be trusted by a relying party such as an external authorized node 104a to properly follow commands, and to submit or transmit valid digital files. For example, falsified input digital files that are transmitted to the controller 204 or the external authorized node 104a, or improper or compromised operation of the computer-controlled device 102a, or falsified digital files outputted by the computer-controlled device 102a and transmitted as the sensed stimulus, may cause severe damage to the system 200 and the planned scheme of delivery may go wrong. The trust system 208 ensures that the computer-controlled devices 102 are free of any maliciously erroneous information, or malicious operations, that may cause a compromise with other parts of the network, as well as other connected networks and systems. The trust system 208 may further provide support to potential network peers wishing to verify their identity and/or integrity before interacting with a connection to the network 106 or the gateway 228. Policies defining the permissions between local users, devices, operations and resources may be facilitated to rely on accurate trustworthiness information arriving as the sensed stimulus.

In an example, a query agent 230 may be installed in, and may run on the computer-controlled device 102a. The trust system 208 may query the query agent 230 for trustworthiness, and may comprise the means to validate and/or process (e.g., act upon) incoming trustworthiness reports from the query agent 230. In some implementations, the query agent 230 may be integrally embedded in, or may be integrated in, or may be an integral part of, the computer-controlled device 102a. In other implementations, the query agent 230 may be an add-on module or unit which may be added to, or coupled to, or be operationally associated with the computer-controlled device 102a. A caching agent 232 may be included within the computer-controlled device 102a and connected with the query agent 230. In an example, the caching agent 232 may be a standalone device, and/or the caching agent 232 may be installed in (or may be part of) the query agent 230. The caching agent 232 may cache trustworthiness digital files and submit to the query agent 230 upon a query from the query agent 230 based on a request from the system 200. The trust system 208 may associate a trust score based on the trustworthiness digital files received from the query agent 230. In an example, the sensed stimulus may contain the trustworthiness digital files. In an example, the trustworthiness digital files may be received as a separate electric signal from the query agent 230. The trustworthiness digital files may contain information about one or more trustworthiness attributes of the computer-controlled device 102a. The trust system 208 may pre-define a plurality of security policies in association with real-time obtained one or more trustworthiness attributes associated with the computer-controlled device 102a and generate a trust score accordingly. The trust system 208 may then apply the security policies based on the received one or more trustworthiness attributes from the computer-controlled device 102a and the determined trust score to enforce a digital transaction over the network 106. The security policies may include outright rejection of the sensed stimulus, authorizing the sensed stimulus as reliable and trustworthy, allowing interference of the digital information contained in the sensed stimulus on the planned scheme of delivery to a limited level only in view of the trust score.

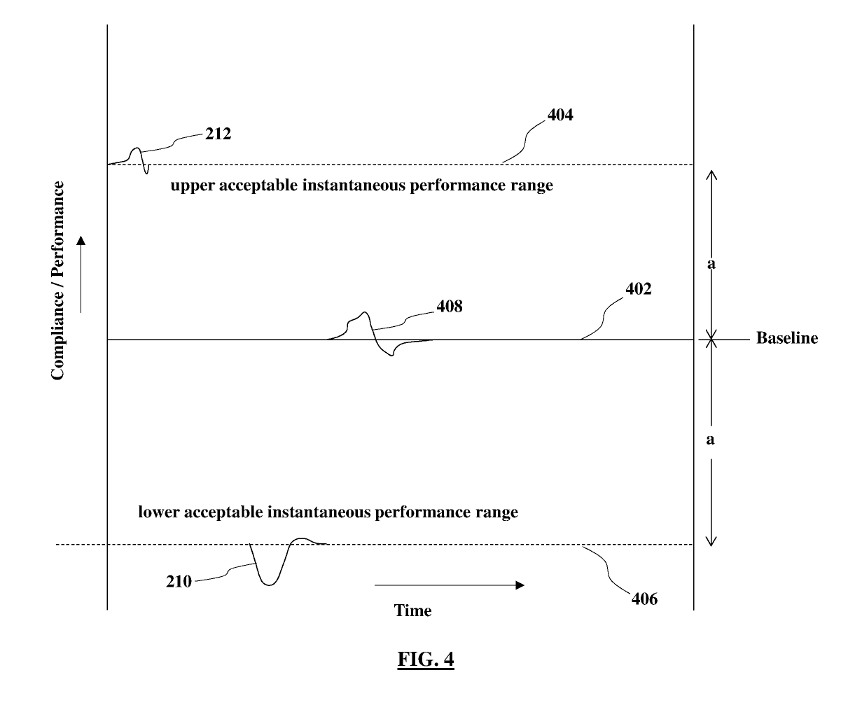

The sensed stimulus may contain an electric compliance component such that the electric compliance component is an electric signal component indicative of performance or compliance by the subject associated with the computer-controlled device 102a toward an existing planned scheme of delivery. The controller 204 may include a tracking device 218 so that the tracking device 218 may decipher the sensed stimulus and filer the sensed stimulus to detect the electric compliance component and to track compliance by the subject by monitoring the electric compliance component in real-time. In an embodiment, the memory unit 212 may store a baseline value for the compliance, shown in FIG. 4, so that the compliance may be matched against the baseline value and checked for deviations. The memory unit 212 may also maintain an acceptable upper range and an acceptable lower range of compliance deviations so that any deviations beyond the acceptable ranges may trigger an alarm device 220 to generate a warning signal and a transmitter 222 for transmitting the warning signal to the computer-controlled device 102a associated with the node. The transmitter 222 may be communicatively and operatively connected with the communication circuit 210. The tracking device 218 generates an output signal (including a light, sound, vibration, or electric signal, etc.) which may be indicative of either the compliance by the node below (or out of specified ranges) a baseline or the compliance by the node within the acceptable ranges or equal to the baseline. The baseline value may represent a digitally maintained dynamically updating minimum threshold level for the node to qualify for compliance in accordance with the planned scheme of delivery stored as the computer-executable files and transmitted to the respective computer-controlled device 102a for execution and compliance.

In an embodiment, the alarm device 220 may be programmed to generate the warning signal if the compliance goes out of the specified range as indicative from the electric compliance component of the sensed stimulus received from the computer-controlled device 102a. For example, if a patient is allowed or prescribed to use a specified medicine at least thrice a day and not more than five times a day, and the system 200 monitors the patient to be medicated less than the lower limit (e.g., three times a day) or more than the upper limit (five times a day) as indicative from the sensed stimulus, the warning signal may be generated by the alarm device 220 and transmitted to the computer-controlled device 102a. In some embodiments, the alarm device 220 may be programmed to generate the warning signal based on defined pre-programmed instructions that can be stored in the memory unit 212. The alarm device 220 can be configured to be coupled to the tracking device 218 so that the output generated by the tracking device 218 in terms of compliance or non-compliance as indicative from the sensed stimulus can be used by the alarm device 220 to decide if the criteria of generating the warning signal is met or not. If the alarm device 220 decides and calculates that the criteria are met, then the warning signal can be sent.

In an embodiment, the warning signal can be sent to a mobile phone, cellular device, pager, computational unit, or any other similar device. In an embodiment, the alert can be sent in the form of a short message (SMS), a mobile phone text message, an audible sound, a vibration, a visual display, an instant message, or any other form of reminder or alert.

The baseline value (or simply referred to as baseline) may be generated and dynamically updated by a baseline generator 224. In an embodiment, the baseline generator 224 may utilize a second computerized input from the authorized external node 104a to generate the baseline value. In an embodiment, the baseline generator 224 may use the sensed stimulus and in particular the electric compliance component together with an ongoing planned scheme of delivery and the identity information of the node associated with the computer-controlled device 102a to determine the baseline value. The baseline generator 224 may update the baseline value dynamically as and when any of various baseline parameters utilized in generating the baseline value changes. The baseline generator 224 further identifies the upper and lower ranges of compliance and updates them dynamically based on the baseline parameters and based on the real time instantaneous contextual absolute values and contextual changes. The computer-controlled device 102a may be informed about the dynamic updates in the baseline value through a transmitted signal which may display as specially-arranged digital pixels on a display device of the computer-controlled device 102a.

The controller 204 may be configured to attest veracity and trustworthiness of the sensed stimulus based on the inputs received from the blockchain configured identity validation device 206 and the computerized trust system 208. An attestation by the controller 204 may be indicative of a suggested change in the digital planned scheme of delivery based on the sensed stimulus if the sensed stimulus indicates a need to make any change in the planned scheme of delivery. However, if the inputs received from the blockchain configured identity validation device 206 and/or the computerized trust system 208 indicates either a lack of trust or an inaccuracy, the controller 204 may not attest information contained within the sensed stimulus. This may be either because the source is not reliable enough or the information is not accurate enough to asynchronously take a decision about a change in the existing planned scheme of delivery for such as a subject.

The controller 204 may also be configured to attest the identity of the external authorized node 104a based on a node token received by the controller 204 from the external authorized node 104a to verify identity and authority of the external authorized node 104a. The node token from the external authorized node 104a may represent a unique digital identity of the external authorized node 104a which may be compared with pre-stored information in the first digital information database 214. In an embodiment, only authorized credentialed nodes may be allowed to view the information contained in the sensed stimulus and provide annotations on top of them and suggest any changes in the planned scheme of delivery to the subject, and/or create a new planned scheme of delivery, etc. If the controller 204 successfully verifies the identity of the computer-controlled device 102a which generates the sensed signal and the associated node, identity of the authorized external node 104a, and attest veracity and trustworthiness of the sensed stimulus, the controller 204 may further cause the blockchain configured network 106 to update the digital planned scheme of delivery for the determined change in the digital planned scheme of delivery as identified through the digital input by the authorized external node 104a. The controller 204 may trigger the communication circuit 210 to inform the computer-controlled device 102a about the change in the planned scheme of delivery or about a new planned scheme of delivery altogether. The controller 204 may include a cognitive rules-based validation device 226 which is discussed hereafter. The cognitive interactive human-machine interface 202 may be coupled to a hardware-based multi gateway 228 which is discussed below.

FIG. 3, with reference to FIGS. 1 and 2, illustrates the computer-controlled device 102a communicatively connected with associated devices that generate the sensed stimulus so that the computer-controlled device 102a may transmit the sensed stimulus to the controller 204 through the cognitive interactive human machine interface 202 facilitating the digital transactions. In an embodiment, at least a few of the associated devices may be integral components of the computer-controlled device 102a. In an embodiment, the associated devices may be separately and discretely located but operatively and/or communicatively coupled to the computer-controlled device 102a.

As shown, the computer-controlled device 102a may be communicatively coupled to a physiological sensor 302. In an example as shown, the physiological sensor 302 may be implanted within a subject's body so as to sense contextual changes or contextual physiological determinants or intrinsic physiological parameters to be transmitted in the form of the sensed stimulus or a physiological signal or a signal component of the sensed stimulus by the computer-controlled device 102a to the controller 204. In an example, the physiological sensor 302 may be percutaneously implanted within a subject's body such as a pacemaker, electrical lead, and the like. In examples, the physiological sensor 302 may detect a physiological characteristic associated with the subject such as but not limited to a ventricular signal, atrial signal, pulse, blood flow rate, blood pressure, heart beat rate, neural compressions, and the like. The physiological signal may be contained within the sensed stimulus as a physiological signal component of the sensed stimulus. The tracking device 218 of the controller 204 may be configured to process the physiological signal component of the at least one sensed stimulus to assess the physiological parameters of the subject. For example, the physiological signal may indicate an inappropriate heart rhythm so that the controller 204 may track the inappropriate heart rhythm and cause the external authorized node to make a change in the digital planned scheme of delivery. In an embodiment, the physiological sensor 302 may not be implanted within a body, rather, the physiological sensor 302 may be positioned as a wearable or an external medical device to sense the contextual settings or determinants so as to transmit information indicative of intrinsic or extrinsic physiological parameters in context in real-time to the controller 204.

The computer-controlled device 102a may be communicatively and/or operatively connected with an environment sensor 304 to detect environmental parameters and transmit them digitally as the sensed stimulus in real-time to the controller 204. The sensed stimulus may contain an electric signal component containing information indicative of the detected environmental parameters and associated contextual values in real-time. The environment sensor 304 may for example be configured to sense location information, light, rain, water levels, moisture content, temperature, movements, sound, atmospheric pressure, and various other types of environmental or contextual parameters. In an example, the environment sensor 304 may comprise various internet-enabled devices such as IoT-based devices to automatically detect surrounding information and transmit them to the controller 204 through the computer-controlled device 102a.

The computer-controlled device 102a may be coupled to various unstructured or semi-structured data-generating devices 306 associated with the node and configured to sense digital parameters indicative of compliance by the subject and generate the electric compliance component of the sensed stimulus as discussed above. The computer-controlled device 102a may be coupled to various structured data-generating devices 308 associated with the node and configured to sense the digital parameters indicative of compliance by the node and generate the electric compliance component of the sensed stimulus. The various unstructured or semi-structured data-generating devices 306 and the structured data-generating devices 308 may include manual sources or automated sources that may gather compliance information regularly.

In various embodiments, the sensed stimulus or various signal components thereof such as indicative of the physiological parameter, compliance, environmental change etc. may be indicative of one or more of the digital parameters. The digital parameters may represent instantaneous environmental determinants, instantaneous social determinants, and instantaneous physiological determinants that may represent specific values sensed by the devices coupled to the computer-controlled device 102a at particular instants of time. For example, an environment sensor 304 may detect pressure levels at a particular time so that the environment sensor 304 may transmit this detected pressure value as an instantaneous pressure value for digitally detected pressure parameter. Similarly, the physiological sensor 302 may sense the ventricular rhythm at a particular instant of time and transmit it as an instantaneous rhythm value indicative for digitally detected ventricular rhythm parameter.

In embodiments, the controller 204 may receive the instantaneous sensed values as part of the sensed stimulus and process the instantaneous sensed values. The controller 204 may further include the cognitive rules-based validation device 226 (as shown in FIG. 2) to determine patterns within the digital parameters based on the at least one sensed stimulus containing the instantaneous sensed values associated with the digital parameters. The memory unit 212 may store historical values associated with the digital parameters for a particular subject so that the cognitive rules-based validation device 226 may determine routine or usual or normal values of the digital parameters associated with the subject based on the historical values. The cognitive rules-based validation device 226 may further compare the instantaneous sensed values for the digital parameters with the routine and usual values of the digital parameters indicative of routine digital data including routine environmental determinants, routine social determinants, and routine physiological determinants. The cognitive rules-based validation device 226 may generate a digital output upon comparison to identity a deviation in the instantaneous values from the routine values associated with the digital parameters so that the deviation is identified as one of an anomaly or a criticality in usage. The anomaly may not be considered as a major cause of concern; however, the criticality in usage may cause the controller 204 to generate an alarm.

In an embodiment, the cognitive rules-based validation device 226 may determine the patterns within the digital parameters based on the sensed stimulus and associate the determined patterns with historical routine digital data comprising routine environmental determinants, routine social determinants, and routine physiological determinants to identity a deviation so that the deviation is identified as one of an anomaly or a criticality in usage.

The cognitive interactive human-machine interface 202 may be coupled to the hardware-based multi-device gateway 228 such that the hardware-based multi-device gateway 228 may couple the computer-controlled devices 102 to an application and physical device and a network associated with the cognitive interactive human-machine interface 202. Embodiments of the hardware-based multi-device gateway 228 may enable system-level communication between a software client and a physical device and can provide for a generic data access and management of data from computer-controlled devices. The hardware-based multi-device gateway 228 can provide for a generic communication between any device and any application layer of a software client, by virtualizing the physical device such that the physical device is exposed as a networked device on a system server.

FIG. 4, with reference to FIGS. 1 through 3, illustrates an exemplary chart to indicate monitoring of compliance by the tracking device 218 using the electric compliance component of the sensed stimulus. In FIG. 4, line 402 represents a baseline value, line 404 represents an upper acceptable range, and line 406 represents a lower acceptable range beyond the baseline value for compliance toward a particular aspect of the planned scheme of delivery or digital medical parameter. In embodiments, each subject may be associated with a computer-controlled device such as 102a which again may be connected to multiple associated devices and sensors. In an example, there may be multiple physiological sensors monitoring multiple medical parameters so that the sensed stimulus may contain a respective compliance component for even more than one aspect or medical parameters. In such cases, multiple baseline values may be associated to monitor compliance for more than one aspect. For example, a baseline value may be associated for monitoring heart rhythm; another baseline value may be associated for medication delivery using an automated injecting machine at required intervals as per prescriptions. The digital baseline chart shown in FIG. 4 depicts only one baseline value 402 for a single exemplary electric compliance component. The electric compliance component may be converted by the tracking device 218 as a graphical representation on a display device in the way shown as below such that peaks and troughs beyond the baseline value may represent deviations. These deviations may be acceptable if they occur within the acceptable ranges. For, example, a signal component 408 represents fluctuations beyond the baseline value but within the acceptable ranges. However, signal components 210 and 212 lie beyond the acceptable baseline ranges and may be considered as potential deviations needing special immediate care.

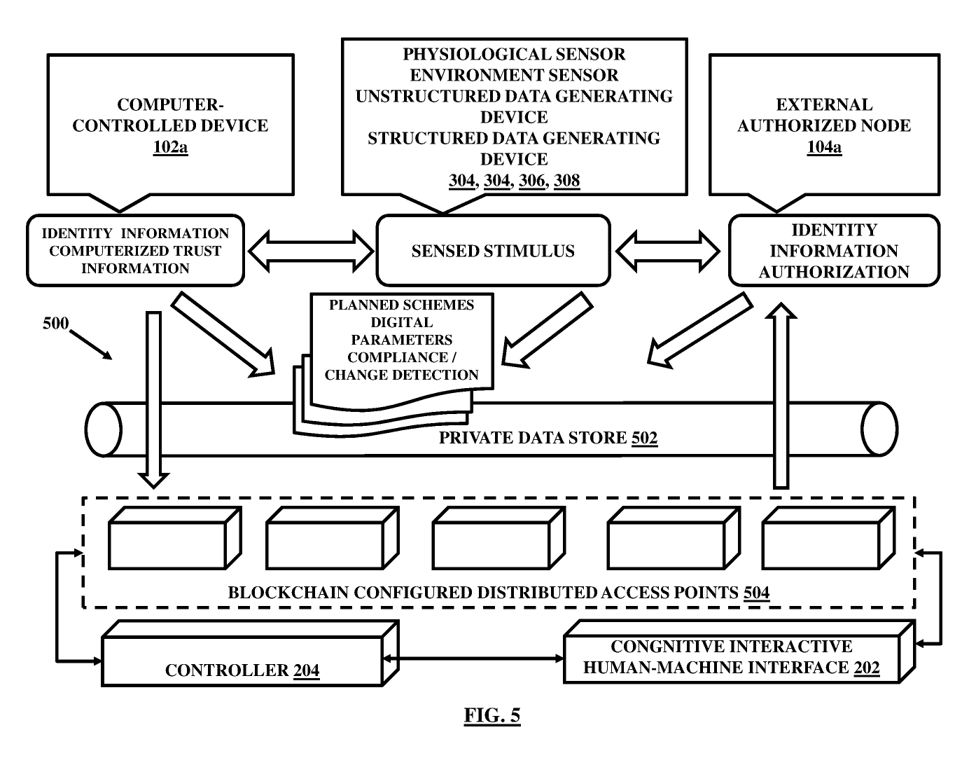

As discussed above, the entire ecosystem 200 may be enabled through the blockchain configured network 106 for ensuring trustworthiness and accuracy across the distributed nodes and associated devices. FIG. 5, with reference to FIGS. 1 through 4, illustrates such an exemplary blockchain configured ecosystem 500 for facilitating the digital transactions among various devices, machines, nodes etc., as discussed earlier in conjunction with various figures.

The blockchain configured cognitive interface human-machine interface 202 may provide a private view to connected devices and nodes such as including the computer-controlled devices 102 and associated nodes, external authorized nodes 104 and their associated computing systems and the like, who may want to access the system 200 based on access rights as a private data store 502 so that each node can privately access certain documents and instructions based on various policies through the hardware-based multi device gateway 228. The nodes may access the dedicated private store 502 available through the plurality of distributed blockchain configured access points 504 which may be enabled in the form of distributed blocks by the cognitive interactive human-machine interface 202 as shown in FIG. 5, with each block providing a facility to access the blockchain configured network 106 by the nodes and associated devices at the same time based on defined and granted access rights.

The private data store 202 may provide a virtual storage to facilitate interaction, information exchange, reviewing, and presentation of digital data and instructions according to granted access. The private data store 202 may be configured to auto-hash interactions at any required interval. This compartmentalization ensures that the data shared across the network is secured and private as per access rights. The data presented on the private data store 202 of the blockchain serves as a secure way to ensure that the private data store 202 is in sync with any permissioned access. The data shared on the private data store 202 may include such as the sensed stimulus and any other digital information arriving from such as the computer-controlled-device 102a, its associated sensors including the physiological sensor 302, environment sensor 304, unstructured data generating device 306, structured data generating device 308, information received as instructions, annotations, changes in the planned scheme of delivery, or instructions for a new planned scheme of delivery from the external authorized node 104a, and the like. Each connected node or device may be associated with its unique identity information and computerized trust information for identity and accuracy verification as above.

In an embodiment, the blockchain configured digital ecosystem 500 may provide a federated blockchain consisting of several entities/participants and associated computers and devices and sensors that jointly access the digital data through a trusted, secured and distributed network of the blockchain configured access points 504. Federations can be organized by systems of care such as identified by geography; e.g., community or state. In an example, the federated blockchain may be applied on top of an existing health information exchange community as a way to further reduce costs and help the community reach financial sustainability.

In accordance with an embodiment herein, the digital data may be accessed upon authorization and access rights verification such that these rights may be dynamically updated in accordance with the contextual information received from the nodes and associated devices and sensors. The blockchain configured controller 204 may be configured to validate identity of the nodes and associated devices accessing the data to establish a trusted information access process. The blockchain configured controller 204 may utilize a variety of identity validation algorithms and schemes such as but not limited to facial expressions, geographical coordinates, geo-tags, gestures, muscle activity, and the like. In accordance with a specific type of validation scheme utilized by the blockchain configured controller 204, a validation scheme-based device may be utilized by the controller 204.

In an embodiment, the system 200 may find applications in a variety of environments including but not limited to healthcare units. The system 200 may, for example, facilitate assess of health levels of patients assuming that patients are subscribed to a service provided through the system 200 by registering with the system 200 and interconnecting the nodes and associated devices within the networked system 200. The health assessment can be performed based on computerized records obtained from the computer-controlled devices 102 through the sensed stimulus. In an embodiment, the information submitted by the computer-controlled devices 102 can also be included as a source of digital data for health assessment of patients by the system 200.

In an embodiment, the system 200 can facilitate performance or compliance tracking for monitoring patients based on issued recommendations. In an embodiment, any recommendation or suggestion received from healthcare providers for a particular patient can be considered as a basis for monitoring or tracking the patient performance. In case the patient defaults in performance, the system 200 may transmit a single indicative of defaults in the performance on a regular basis such as daily, weekly, monthly, and the like. The system 200 may also generate reports that provide an assessment of the performance of the patient. In an embodiment, the reports can be accessed by the computer-controlled devices 102 when desired. In an embodiment, the reports can be automatically transmitted to the computer-controlled devices 102 periodically. This may enable a collaborative digital engagement of those interested and concerned for the health of the patient.

The system 200 may be utilized to facilitate collaborative digital engagement in healthcare ecosystems for assessing health of patients, developing digital health plans, tracking, and monitoring of patient performance regarding health, and updating about performance compliance of the patients through the computer-executable files generated and/or updated by various devices in the network 106.

The system may facilitate tracking or monitoring digital health parameters of patients through signals received from the computer-controlled devices 102 indicative of health of the patient. The tracking can be performed on a regular basis or can be time bound such as for a defined period of time. The tracking can be performed in order to make a health assessment or generate planned scheme of delivery for the patient.

The system 200 may facilitate assessing the digital health parameters of the patient based on digital outputs generated after tracking the digital health parameters of the patient. The system 200 can generate computerized reports in the form of computerized guidelines, manuals, recommendations, or suggestions for the patient based on information collected after tracking the digital health parameters and assessing the digital health parameters of the patient.

In an embodiment, the second digital information database 216 and the first digital information database 214 store computerized information pertinent to the patients including demographic information, and health related information of the patients, and information pertinent to the healthcare providers or the healthcare provider-related entities associated with the patients in order to develop or manage digital health plans for the patients, and information collated by the healthcare providers and the healthcare provider-related entities as obtained from the patients and the patient-related entities. The second digital information database 216 is coupled to the first digital information database 214 and retrieves information partially from the first digital information database 214.

In accordance with various embodiments, various types of collaborative digital engagement may be facilitated by the ecosystem 100. In an embodiment, the ecosystem 100 may facilitate digital engagement of the type including ‘person-entered structured’ content. The ‘person-entered structured’ content may include records such as from electronic health or medical bank or any other similar source for example, electronic health records. In another embodiment, the ecosystem 100 may facilitate digital engagement of the type including ‘person-entered semi-structured’ content. The ‘person-entered semi-structured’ content may include records for example from a combination of databases and records in the form of free-text. In another embodiment, the ecosystem 100 may facilitate digital engagement of the type including ‘person-entered unstructured’ content. The ‘person-entered unstructured’ content may include records in the form of, for example, natural or free text (either by patient, their related entity, healthcare provider, or healthcare provider related entity). In another embodiment, the ecosystem 100 may facilitate digital engagement of the type including ‘lab-generated structured’ content for example biomarkers, biometric, etc. In another embodiment, the ecosystem 100 may facilitate digital engagement of the type including ‘device-generated structured’ content such as obtained from a plurality of medical devices automatically. In still other embodiments, the ecosystem 100 may facilitate digital engagement of any other type or of the type including any other type of content or a combination of those mentioned here.

In an example, the embodiments herein can provide a computer program product configured to include a pre-configured set of instructions, which when performed, can result in actions as stated in conjunction with the method(s) described above. In an example, the pre-configured set of instructions can be stored on a tangible non-transitory computer readable medium. In an example, the tangible non-transitory computer readable medium can be configured to include the set of instructions, which when performed by a device, can cause the device to perform acts similar to the ones described here.

The embodiments herein may comprise a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer-executable instructions or data structures stored thereon.

Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

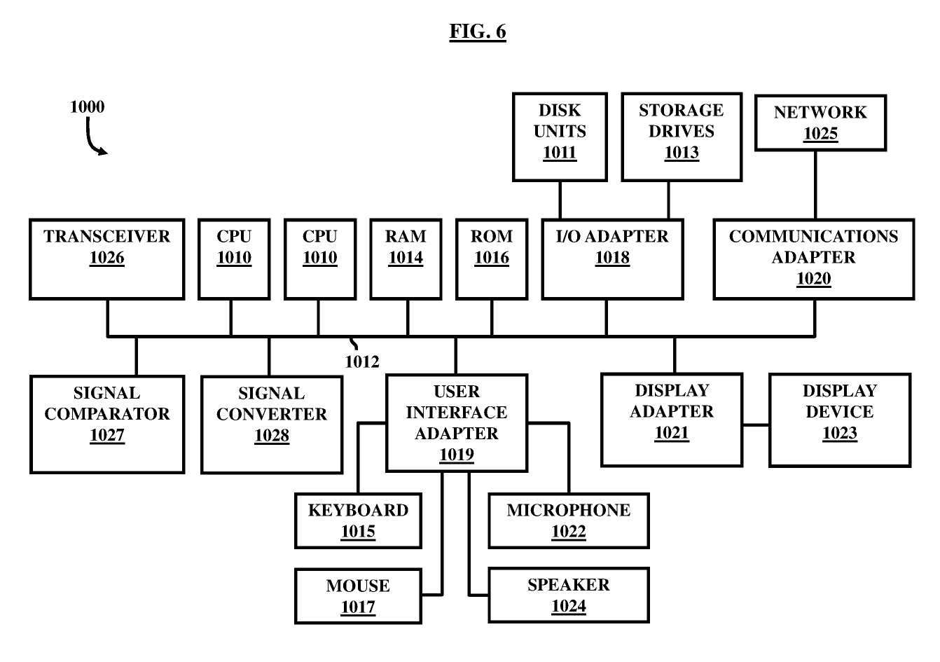

A representative hardware environment for practicing the embodiments herein is depicted in FIG. 6, with reference to FIGS. 1 through 5. This schematic drawing illustrates a hardware configuration of an information handling/computer system 1000 in accordance with an exemplary embodiment herein. The system 1000 comprises at least one processor or central controller (CPU) 1010. The CPUs 1010 are interconnected via system bus 1012 to various devices such as a random access memory (RAM) 1014, read-only memory (ROM) 1016, and an input/output (I/O) adapter 1018. The I/O adapter 1018 can connect to peripheral devices, such as disk units 1011 and storage drives 1013, or other program storage devices that are readable by the system. The system 1000 can read the inventive instructions on the program storage devices and follow these instructions to execute the methodology of the embodiments herein. The system 1000 further includes a user interface adapter 1019 that connects a keyboard 1015, mouse 1017, speaker 1024, microphone 1022, and/or other user interface devices such as a touch screen device (not shown) to the bus 1012 to gather user input. Additionally, a communication adapter 1020 connects the bus 1012 to a data processing network 1025, and a display adapter 1021 connects the bus 1012 to a display device 1023, which provides a GUI (e.g., a gadget) in accordance with the embodiments herein, or which may be embodied as an output device such as a monitor, printer, or transmitter, for example. Further, a transceiver 1026, a signal comparator 1027, and a signal converter 1028 may be connected with the bus 1012 for processing, transmission, receipt, comparison, and conversion of electric or electronic signals.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A distributed-architecture based-system for facilitating collaborative asynchronous digital transactions enabled through a blockchain configured digital integrity network among a plurality of computer-controlled devices associated with a plurality of respective nodes, said system comprising:
a first digital information database to store computerized identity files pertaining to said plurality of respective nodes and said associated plurality of computer-controlled devices;
a cognitive interactive human-machine interface configured to allow said plurality of computer-controlled devices and said associated nodes to interact digitally among them and with said system and with an external authorized node, wherein said cognitive interactive human-machine interface is configured to receive at least one sensed stimulus from at least one of said computer-controlled devices and transmit digital information contained in said at least one sensed stimulus at least in part to said external authorized node to annotate said digital information by generating a digital input, wherein said digital input is indicative of a change or no change in a digital planned scheme of delivery for a node associated with said at least one of said computer-controlled devices that generates said at least one sensed stimulus;
a controller communicatively connected with said authorized external node and with said cognitive interactive human-machine interface to process said at least one sensed stimulus for comprehension and conversion into said digital information for transmission to said external authorized node and to process said digital input received from said external authorized node, wherein said controller comprises:
a blockchain configured identity validation device to verify identity of said at least one of said plurality of computer-controlled devices generating said sensed stimulus based on said pre-stored identity information in said first digital information database and an electronic signature received from said at least one of said computer-controlled devices along with said at least one sensed stimulus;
a computerized trust system including a memory circuit and a special purpose processor that evaluates trustworthiness and device integrity of said at least one of said computer-controlled devices that generates said at least one sensed stimulus associated with said respective node participating in said asynchronous digital transactions and generate a digital signal indicative of a trust score associated with said at least one of said computer-controlled devices and said associated node;
wherein said controller is configured to:
attest veracity and trustworthiness of said at least one sensed stimulus based on inputs received from said blockchain configured identity validation device and said computerized trust system such that an attestation is indicative of a change in said digital planned scheme of delivery based on said sensed stimulus; and
attest identity of said external authorized node based on a node token received by said controller from said external authorized node, wherein said node token represents a unique digital identity of said authorized external node;
cause said blockchain configured network to update said digital planned scheme of delivery in view of said determined change in said digital planned scheme of delivery as identified from said digital input received from said external authorized node; and
notify said at least one of said computer-controlled devices of said determined change; the notifying comprising:
generating an electric signal comprising data signifying said determined change and instructions for compliance toward an updated digital planned scheme of delivery;
transmitting said electric signal in said network comprising said plurality of communicatively linked computer-controlled devices;
converting said electric signal into a plurality of pixels; and
displaying said plurality of pixels on a display unit of said at least one of said computer-controlled devices to launch an activation message that includes an instruction in accordance with said determined change and said updated planned scheme of delivery.

2. The system of claim 1, further comprising a second computerized information database to store computer-executable files indicative of digital parameters and respective reference values for use in updating and creating said planned scheme of delivery for said node associated with said at least one of said computer-controlled devices.

3. The system of claim 2, wherein said at least one of said computer-controlled devices is operatively coupled to a physiological sensor configured to generate a physiological signal component of said at least one sensed stimulus associated with said node such that said controller further comprising a tracking device configured to process said physiological signal component of said at least one sensed stimulus to assess information pertaining to one or more of said digital parameters associated with said node.

4. The system of claim 3, wherein said tracking device generates an output indicative of:
said compliance by said node within a baseline value range; or
said compliance by said node beyond said baseline value range, wherein a baseline value represents a digitally maintained dynamically updating minimum threshold level for said node to qualify for compliance in accordance with said planned scheme of delivery stored as said computer-executable files and transmitted to said at least one of said computer-controlled devices by said controller.

5. The system of claim 4, wherein said controller further comprises an alarm device to generate an alarm signal and a transmitter to transmit said alarm signal to said node if said performance is detected to go beyond said baseline value range.

6. The system of claim 3, wherein said physiological sensor is implanted within said node subcutaneously or positioned over an external surface so as to detect intrinsic physiological parameters at regular intervals and transmit them as said at least one sensed stimulus in real-time to said controller.

7. The system of claim 1, wherein said at least one of said computer-controlled devices is operatively connected to an environment sensor to detect environmental parameters and transmit detected information as said at least one sensed stimulus in real-time to said controller.

8. The system of claim 1, wherein said at least one of said computer-controlled devices is connected to an unstructured or semi-structured data-generating device associated with said node and configured to sense at least one of a set of digital parameters indicative of compliance by said node.

9. The system of claim 1, wherein said at least one of computer-controlled devices is connected to a structured data-generating device associated with said node and configured to sense at least one of a set of digital parameters indicative of compliance by said node.

10. The system of claim 1, wherein said at least one sensed stimulus is indicative of collected sensed information corresponding to instantaneous environmental determinants, instantaneous social determinants, and instantaneous physiological determinants associated with a set of digital parameters such that said controller further comprising a cognitive rules-based validation device to determine patterns within said digital parameters based on said at least one sensed stimulus and associate said determined patterns with historical reference values corresponding to routine environmental determinants, routine social determinants, and routine physiological determinants to identity a deviation so that said deviation is identified as one of an anomaly or a criticality in usage from said reference values.

11. The system of claim 1, wherein said cognitive interactive human-machine interface further comprising a hardware-based multi-device gateway to communicatively connect with said plurality of computer-controlled devices, wherein said hardware-based multi-device gateway is configured to transmit instructions to said controller based on said sensed stimulus to execute a set of computer-executable custom rules for allowing said digital transactions over said blockchain configured network.

12. The system of claim 1, wherein said controller further comprising a baseline generator to generate a baseline value, an upper acceptable range, and a below acceptable range for a respective digital parameter in association with a node associated with said at least one of said computer-controlled devices based on said sensed stimulus, and wherein said controller is configured to use an input from said baseline generator to display deviations of an instantaneous value corresponding to said digital parameter from said baseline value as peaks and troughs on a digital baseline chart.
